(19) United States
(12) Patent Application Publication
(10) Pub. No.: US 2006/0151963 A1
(43) Pub. Date: Jul. 13, 2006

(54) Golf cart towing system

(76) Inventor: Lee R. Epley, Lee's Summit, MO (US)

Correspondence Address: CHASE LAW FIRM L.C, 4400 COLLEGE BOULEVARD, SUITE 130, OVERLAND PARK, KS, 66211, US

(21) Appl. No.: 11/032,979

(22) Filed: Jan. 11, 2005

(51) Int. Cl. B62D 51/04

(52) U.S. Cl. 280/1.5

(57) ABSTRACT

A towing system for a golf cart comprises a flexible tow strap attached to the user with strap ends attached to the axle ends of the strap. A ring, as attached to a belt worn by the user, presents a channel for slidable movement of the strap therethrough. This movement presents a differential action to the tow strap such that forces from the ambulatory user are evenly transferred to the golf cart during cart turns and other deviations of the cart from a straight line path.

### BACKGROUND OF THE INVENTION

This invention relates to a golf cart towing system and, more particularly, to a system which effectively couples a golf cart to ambulatory movement of a user.

The use of a two-wheeled golf cart to reduce the fatigue associated with carrying a golf bag is known. Accordingly, various devices have been introduced for enabling the golfer to tow the cart about the golf course so as to further reduce fatigue.

Past towing devices have not effectively achieved the towing function. Although such devices presented various elements to couple the golf cart to the user movement, problems have arisen when the golf cart is towed in other than a straight line path, such as through turns and/or over uneven surfaces. Absent the ability to exert an even tow force on the opposed wheel axles of the golf cart, interference with a normal ambulatory movement of the golfer arises. This difference diminishes the ability of the golfer to effectively use the larger muscles of the body to tow the golf cart. In such cases, additional hand pulling of the golf cart may be necessary which may present fatigue, cramping and tension in the fingers, wrist, forearm and elbow which may affect the golfer's swing. Such problems arose, in part, due to the rigid coupling utilized between the cart and the user.

In response thereto I have invented a towing system which effectively couples a golf cart to a golfer so that even pressure can be transferred from the large muscles of the ambulatory user to the wheels of the golf cart via a flexible tow strap whether the cart is being towed in a straight line, through turns or over uneven terrain.

My towing device presents structure in the form of a flexible tow strap capable of performing a differential action on the axle ends of the towed golf cart. This action maintains the tow strap in a taut extension between the user and the axle ends of the golf cart such that generally even forces are exerted thereon. In turn, such forces turn the wheels of the golf cart smoothly when the user is moving in directions away from a straight line path.

It is therefore a general object of this invention to provide an enhanced golf cart towing system.

A further object of this invention is to provide a device, as aforesaid, which is easily attached to the user and the golf cart.

Another object of this invention is to provide a device, as aforesaid, which presents flexible structure to present even tow forces on the axle ends of the golf cart during ambulatory movement of the user.

A further object of this invention is to provide a device, as aforesaid, which can be used with golf carts of various designs.

A more particular object of this invention is to provide a system, as aforesaid, which presents a flexible tow strap capable of maintaining a taut extension between the user and cart during ambulatory user movement to present uninterrupted forces thereto.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a side view showing the towing system connected to a golf cart.

FIG. 2 is an enlarged view showing the connection of the tow strap to a belt worn about the user.

FIG. 3 is a top view of the towing system connected to the golf cart and showing in solid lines the action of the towing system in a straight line path and in phantom lines the action of the towing system negotiating a right turn.

FIG. 4 is an enlarged view showing the slidable movement of the first and second tow strap portions through the strap channel and the support ring of the system.

FIG. 5 is an elevation view of the support strap in an elongated position.

FIG. 6 is an elevation view showing the slip ring at the end of the FIG. 5 strap.

FIG. 7 is a top view of the FIG. 6 strap.

FIG. 8 is a view of one end of the tow strap of the system and showing a buckle for adjusting the strap length and ring for attaching the strap end to an axle end.

FIG. 9 is a view of the opposed end of the FIG. 8 tow strap and a ring for attaching the strap end to an opposed axle end.

FIG. 10 is a view of the central portion of the strap with hook thereon.

FIG. 10A is a top view of the FIG. 10 strap.

FIG. 11 is a view of the hook on the tow strap with the strap channel therein.

FIG. 12 is an elevation view of the user's belt of the tow system.

FIG. 13 is an elevation view of an extension for the FIG. 12 belt.

FIG. 14 is an enlarged view taken along line 14-14 in FIG. 12 and showing the attachment of the belt ring to the FIG. 12 belt.

### DESCRIPTION OF THE PREFERRED EMBODIMENT

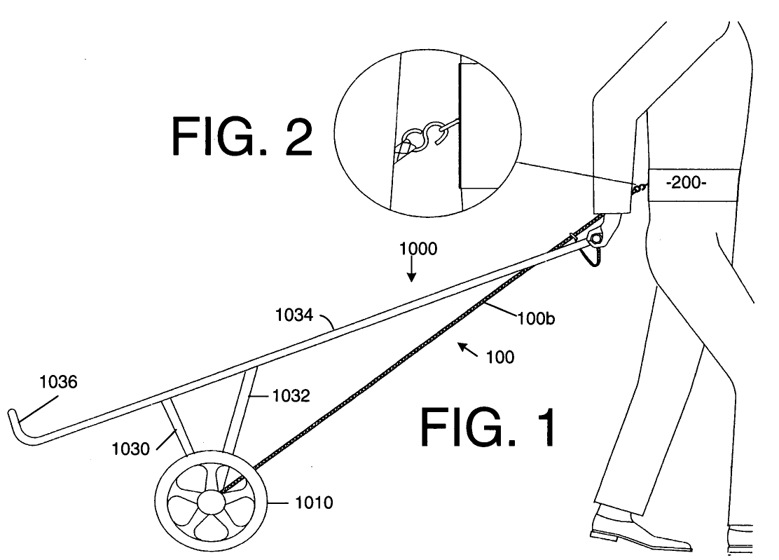

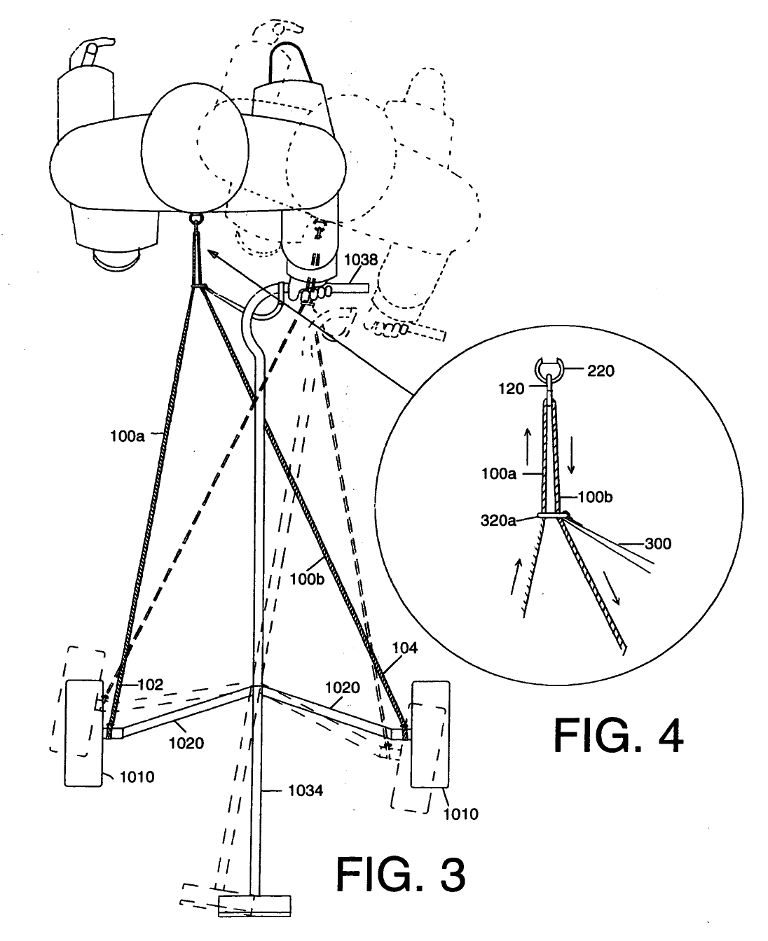

Turning more particularly to the drawings, FIG. 1 shows a view of a basic golf cart 1000 having support wheels 1010 thereon. As shown in FIG. 3, each support wheel 1010 is shown at the end of a stub axle 1020. Extending immediately from the midpoint of the axles 1020 are support brackets 1030, 1032 (FIG. 1) for the bag support strut 1034. One end 1036 of the support strut 1034 provides a base for underlying support to the golf bag. At the opposed end of the support strut 1034 is a handle 1038 for manual gripping by the user.

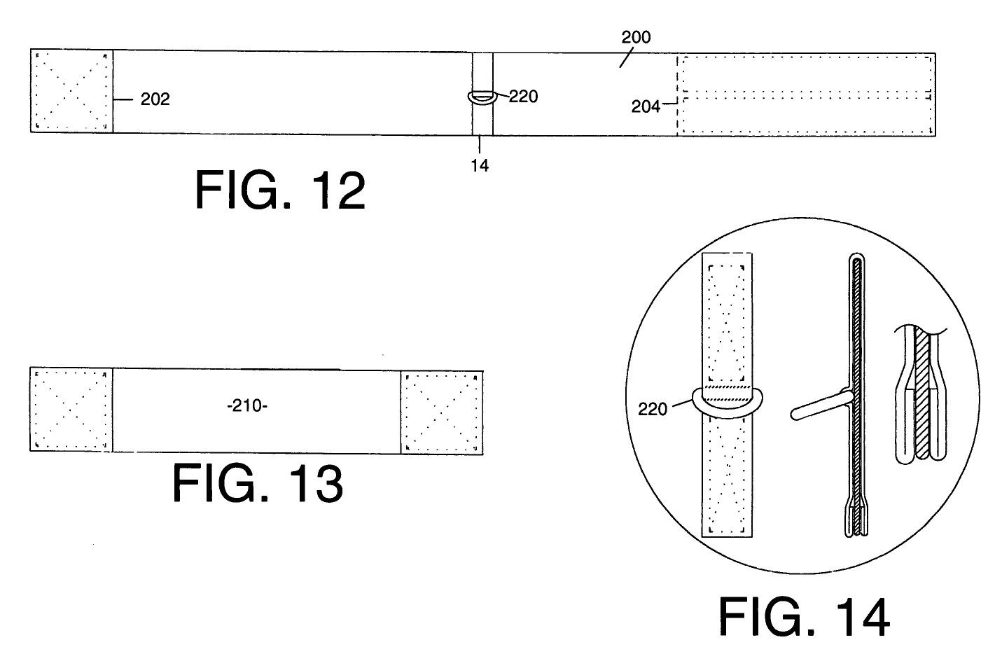

The cart towing system includes an elongated tow strap 100 having first and second ends 102, 104 attached about the stub axles by rings 110. The length of strap 100 is adjustable by buckle 152 which engages complementary buckle 150. The tow strap slidably extends through a closed channel portion 122 of a hook 120 (FIG. 11) which is attached to a ring 220 on a belt 200 worn by the user (FIG. 12). As shown in FIG. 4, the channel defines strap portions 100a, 100b extending between the channel 120 and each respective axle end 1020.

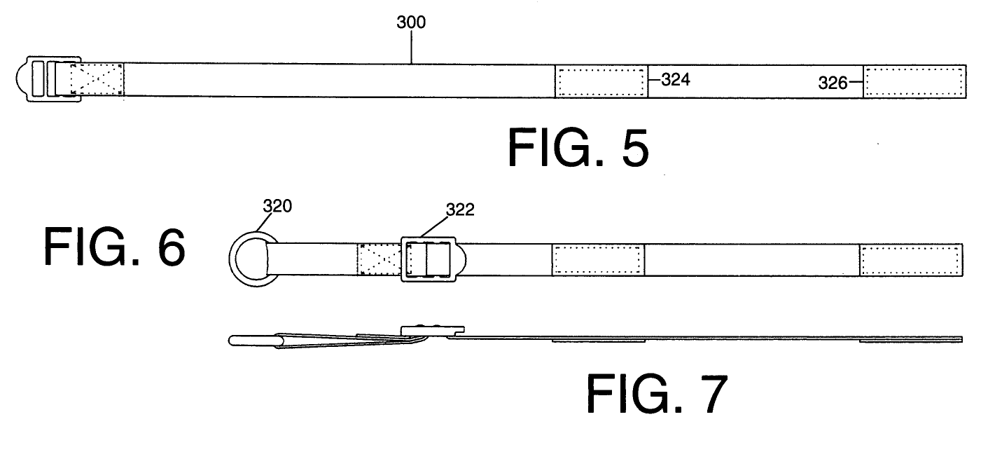

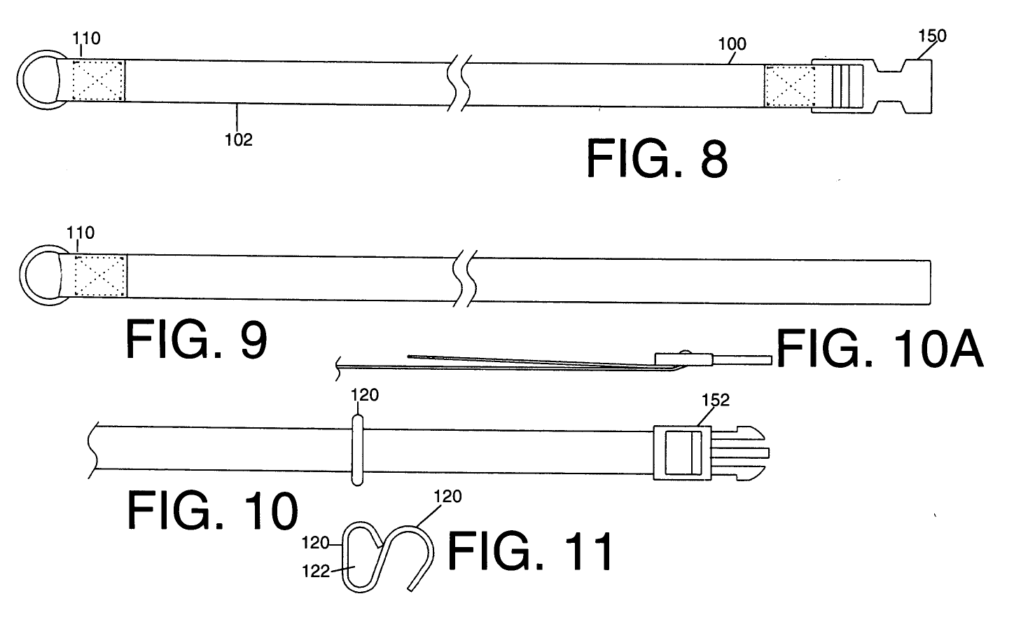

The strap portions 100a, 100b pass through a downstream support ring 320 which is attached to support strap 300 (FIGS. 5-7) attached to the handle 1036 of the golf cart. The length of support strap 300 is adjustable by buckle 322. A mating of complementary Velcro® fasteners 324, 325 present a loop for fastening strap 300 to the golf cart handle 1038.

Belt 200 is fastened about the user by Velcro® fasteners 202, 204. Extension 210 may extend the length of belt 200. As shown in FIG. 4, upon attachment of the hook 120 (FIG. 11) to belt ring 220, first 100a and second 100b portions of the tow strap relative to hook 120 are presented. Ring 320 draws the portions of the tow strap adjacent hook 120 one to the other to enhance slidable movement through channel 120. The support strap 300/ring 320 combination, as attached to handle 1038, further hangs the belt 200 from handle 1038 when removed by the user precluding the belt 200 from ground contact.

As shown in phantom lines in FIG. 3, when the golf cart is towed into a turn deviating from a straight line path (right turn as shown) the combination of the ring 220, hook 120 and channel 122 allow the flexible strap portions 100a, 100b to smoothly slide through hook channel 122. This movement effectively shortens the extension of strap portion 100a between hook 120 and the left axle end 1020 while lengthening the opposed portion 100b between hook and the right axle end. This differential action maintains a taut extension of these strap portions 100a, 100b during ambulatory movement such that an even transfer of forces from the user to axles 1020 occurs. This action arises as the effective length of each tow strap portion, relative to the ring 220 and hook 120, is continuously adjusted according to user movement. (It is understood that a left turn of the cart will result in strap portion 100a lengthening with portion 100b shortening.) As such, during turns the strap portions 100a, 100b remain relatively taut in their respective extension, such that the pulling forces of the user are being smoothly transferred to the stub axles. Thus, the user need not primarily pull the golf cart by hand.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is as follows:

1. A towing device for a golf cart or the like, the cart having a support frame, a handle, an axle with first and second ends and a wheel thereon, said device comprising:
a tow strap having first and second ends;
means for connecting said first and second ends of said tow strap to the first and second ends of the axle;
a ring presenting a channel for slidable movement of said tow strap therethrough;
means for connecting said ring to a user and presenting a first portion of said strap between said ring and the axle first end and a second portion of said strap between said ring and the axle second end, said strap slidable movement through said ring in response to an ambulatory action of a user, said slidable movement of said strap during the ambulatory movement of the user varying the effective length of said first and second strap portions relative to said ring and the respective axle ends to present a taut extension of said strap portion between the user and the axle ends, whereby to present an even transfer of forces from the ambulatory user to said axle ends to tow the golf cart.

2. The towing device as claimed in claim 1 whereby said slidable movement of said strap effectively shortens one of said strap portions and effectively lengthens the other of said strap portions relative to said ring during a deviation of the ambulatory movement of the user from a straight line path, whereby to maintain said taut extension of said strap portions during a turning of the cart.

3. The towing device as claimed in claim 1 wherein said connecting means comprises:
a belt adapted to be worn about the waist of the user; a ring on said belt adapted to extend from a back of the user upon a wearing of said belt;
means for attaching said ring presenting said channel for said strap to said belt ring.

4. The towing device as claimed in claim 1 further comprising means for adjusting the length of said tow strap.

5. The towing device as claimed in claim 3 further comprising:
means for supporting said belt from the cart frame, whereupon a removal of said belt hangs said belt from the frame.

6. The towing device as claimed in claim 5 wherein said supporting means comprises:
a support ring adjacent said ring presenting said channel for passage of said strap portions therethrough; a strap extending from said support ring, said strap having an end connected to the golf cart frame.

7. The towing device as claimed in claim 3 further comprising means for adjusting a length of said belt.

8. A towing device for enhancing the pulling of a cart having a handle, an axle with first and second ends, each end having a wheel thereon, said device comprising:
a tow strap having first and second ends;
means for connecting an end of each strap to an end of the axle;
means for connecting said strap to a user to present first and second strap portions extending from the user to an end of the axle whereby an ambulatory movement of the user tows the cart;
means for adjusting the effective length of said strap portions during a turning movement of the user, whereby said strap portions evenly transfer forces from the ambulatory user during turns to the golf cart.

9. A towing device for enhancing the pulling of cart having a handle, an axle with first and second ends, each end having a wheel thereon, said device comprising:
a flexible strap having first and second ends;
means for connecting an end of each strap to an end of the axle to present first and second strap portions extending from the user to an end of the axle whereby an ambulatory movement of the user tows the cart;
means for providing a slidable movement of the strap relative to the user whereby to adjust the effective length of said strap portions during a turning movement of the users, said adjustment of length maintaining a taut extension of said strap portions during turning to effectively transfer forces from the user to the golf cart.
